(19) United States
(12) Patent Application Publication
(10) Pub. No.: US 2005/0227844 A1
(43) Pub. Date: Oct. 13, 2005

(54) Bag or bag-forming material of a synthetic material for vacuum preservation of articles, particularly of foodstuffs

(75) Inventor: Alberto Malaspina, Ovada (IT)

Correspondence Address: Guido Modiano;Dr. MODIANO & ASSOCIATI S.p.A., Via Meravigli, 16, Milano, 20123, IT

(73) Assignee: NUOVA POLIVER di ODDONE COLOMBA & C. S.n.c.

(21) Appl. No.: 11/148,246

(22) Filed: Jun. 9, 2005

Related U.S. Application Data
(62) Division of application No. 10/189,013, filed on Jul. 5, 2002.

(30) Foreign Application Priority Data
Aug. 3, 2001 (IT) TO2001A000772

(51) Int. Cl. B31B 49/04

(52) U.S. Cl. 493/189

(57) ABSTRACT

The bag consists of two walls made from sheets of a multi-layer, synthetic material, welded together along part of the perimeter. One of the walls has two or three rectilinear, longitudinal rough stripes on its inner surface, obtained by hot-printing and extending substantially along the full length of the bag. The stripes are obtained by pressing a welding bar, coated with a rough, non-adhesive material, such as teflon cloth, against the multi-layer sheet forming the wall of the bag.

### BACKGROUND OF THE INVENTION

This invention relates to a bag or bag-forming material of a synthetic material for the vacuum preservation of articles, particularly foodstuffs in the home.

Nowadays, bags are widely used in the home for protection and preservation of vegetables, meat, cheese and other foodstuffs in refrigerators. These bags consist of two walls of a synthetic material, joined by weldings along three edges. The walls are generally multi-layer sheets made of polyethylene, which material is compatible with foodstuffs but is permeable to gases. Such bags are generally closed by means of knots, clips or the like.

Recently, the practice has become widespread of creating a vacuum in the bag containing the foodstuffs, in order to improve the preservation of foodstuffs subjected to a high risk of deterioration. The walls of the bags (which are welded along three edges) consist of several layers of different materials comprising an inner layer of polyethylene, which material is compatible with foodstuffs but permeable to gases, and a layer of a material that is impermeable to gases, such as polyamide. Therefore, the air is extracted from the bag by means of a vacuum bell, then the bag is hermetically sealed also along the fourth edge defining the mouth, by means of a hot weld.

Such operation cannot be performed in the home, because the air extraction is hindered by the mutual adhesion of the inner surfaces of the bag, which will prevent its areas which are far from the mouth from being completely emptied, and will allow air pockets to survive. Successively, such pockets will spread all over the bag so that the purpose of preventing contact between the foodstuffs and the air will be not achieved.

In order to overcome such drawback, it has been proposed to form bubbles or embossed crests, forming a network of grooves, on one of the walls of the bag, so that the air will be always allowed to find a way towards the mouth, where suction takes place. Although this is an effective method, the extra operations needed for this treatment require high precision and considerably increase the cost of the bag.

### SUMMARY OF THE INVENTION

The main object of the present invention is therefore to provide a bag of a synthetic material for vacuum preserving foodstuffs, which will avoid the drawback of the trapped air pockets and which, at the same time, has low manufacturing costs, i.e. substantially similar to the costs of conventional bags.

Another object of the invention is to provide a bag having a high flexibility and shape adaptability with respect to the article contained in it.

A further object of the invention is to provide a bag which can be manufactured on conventional assembly lines, without a need for complex extra equipments.

The above-mentioned objects and advantages, and other that will become apparent below, are achieved by the invention with a bag of a synthetic material having the features recited in claim 1.

### BRIEF DESCRIPTION OF THE DRAWINGS

The invention will now be described in more detail, with reference to some preferred but not exclusive embodiments shown by way of non limiting example in the attached drawings, wherein:

FIG. 1 is a perspective view of a bag according to a first preferred embodiment of the invention;

FIG. 2 diagrammatically shows a process for manufacturing the bag according to the invention;

FIG. 3 is a perspective view of a second embodiment of a bag according to the invention.

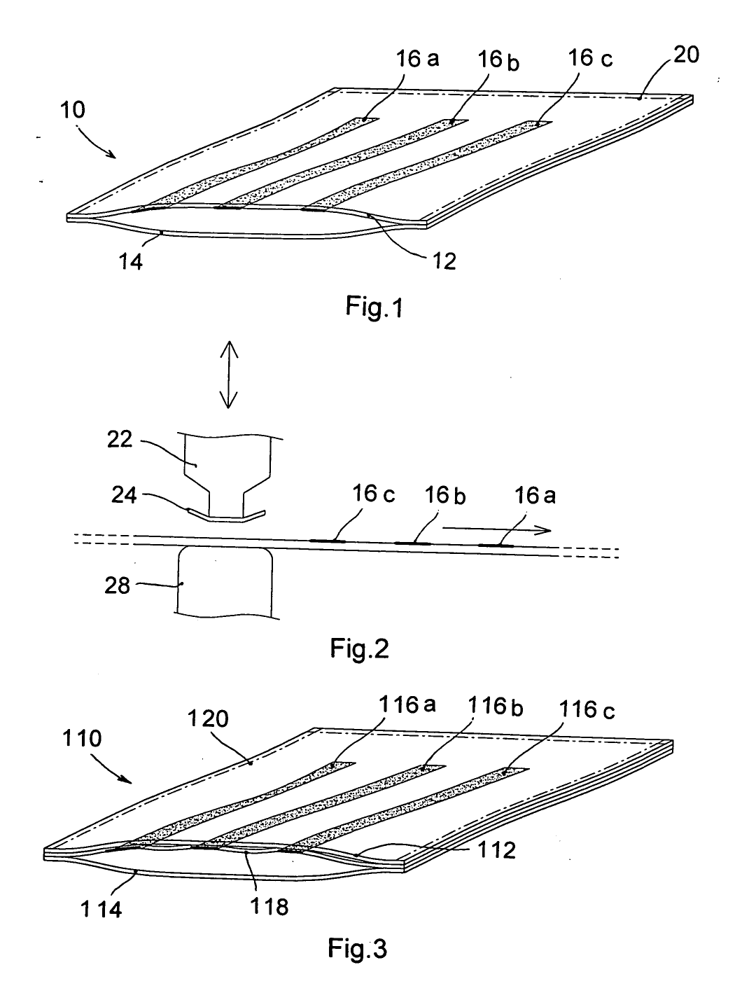

### DESCRIPTION OF THE PREFERRED EMBODIMENTS

With reference to the Figures, a bag 10 has two walls 12, 14 which are hot welded along a peripheral line 20. Each wall is made of a multi-layer synthetic material known per se, consisting of three or more alternating layers of polyamide and polyethylene. The inmost layer is usually made of polyethylene, which material is compatible with foodstuffs and is easy to weld, while one or more of the remaining layers are made of polyamide, which imparts the bag a high mechanical strength and provides it with an effective air leak barrier.

According to the invention, at least wall 12 has three hot-printed, rough stripes 16a, 16b, 16c on its inner surface, which are substantially rectilinear and extend longitudinally, preferably over the full length of the bag.

Although the number of three rough stripes is the most advantageous for bags having common sizes (e.g. about 20 cm×30 cm), their number can be changed, two stripes or only a single stripe being sufficient in the case of long and narrow bags. Also the width of each stripe can be changed, preferably in the range 0.5 cm to 2 cm.

The stripe can be printed, as shown in FIG. 2, by pressing the wall between a welding bar 22, having a welding surface is coated with a rough, non-adhesive material 24 such as a close-mesh teflon cloth, and a smooth counterbar 28. The teflon cloth preferably has 5 to 20 meshes/cm, and more preferably 12 meshes/cm.

In a second embodiment of the bag, shown in FIG. 3, a single-layer, a polyethylene sheet 118 is coupled to wall 112 of the bag, and is joined to wall 112 by means of three rough stripes 116a, 116b, 116c similar to rough stripes 16a, 16b, 16c. The hot imprints forming the stripes are obtained by welding a single-layer sheet 118 to multi-layer sheet 112. Such stripes (the two sheets being welded along them) can be obtained by using the same welding bar (coated with a rough, non-adhesive material) shown with reference to the preferred embodiment.

This approach provides an increased protection of the outer walls against possible micro-fissures which could arise during the impact of the welding bar, particularly in the case of very thin walls and/or walls with only few polyamide layers.

The rough stripes have been found to effectively prevent sticking or adherence between parts of the bag, and therefore forming of air pockets. Such bags can be made by an easy and cheap process, which is simple to be executed on a conventional plant for mass production of conventional bags.

Moreover, since teflon, as well as welding bars, are commonly used for making the peripheral weldings of the walls, the process uses devices, materials and technologies that are common and well known in the field.

A further advantage of the invention is that the stripes do not significantly stiffen the wall of the bag, which therefore retains a high flexibility and shape adaptability with respect to the article contained in it.

The preferred embodiments of the invention which have been described above can be changed in different ways, as will be evident for the person skilled in the art, and particularly the materials and the sizes can be varied.

For example, although the stripe is preferably rectilinear, it may be differently shaped, e.g. S-shaped. Similarly, the stripe may extend only over a longitudinal portion of the bag, rather than over its full length. Materials and sizes can be different from what has been shown, depending on requirements.

Instead of a bag sealed at one end, a bag-forming material may also be marketed, similar to the above described bag, i.e. comprising a tube made of two elongated walls welded together at opposite sides, one of the wall being hot-printed as taught above. A roll of 5 to 10 meters of such a tube is provided to the user, who will cut a desired length of the tube and seal it at one end to form the bag, then at the opposite end after insertion of an article and extraction of air.

The disclosures in Italian Patent Application No. TO2001A000772 from which this application claims priority are incorporated herein by reference.

This invention relates to method of forming a bag or bag forming material of a synthetic material for the vacuum preservation of articles, particularly foodstuffs in the home.

The stripe can be printed, as shown in FIG. 2, by pressing the wall between a welding bar 22, having a welding hot surface is coated with a rough, non-adhesive material 24 such as a close-mesh teflon polytetrafluoroethylene fabric or cloth, and a smooth counterbar 28. The teflon cloth preferably has 5 to 20 meshes/cm, and more preferably 12 meshes/cm.

Moreover, since teflon polytetrafluoroethylene (available, for instance, under the trade name TEFLON), as well as welding bars, are commonly used for making the peripheral weldings of the walls, the process uses devices, materials and technologies that are common and well known in the field.

1-14. (canceled)

15. A process of manufacturing a bag of a synthetic material for vacuum preservation of foodstuffs, comprising the steps of:
mutually joining two walls made of flexible sheets of a synthetic material on three sides along a peripheral welding line;
imprinting on one side of a first of the flexible sheets forming the walls with at least one rough stripe made by pressing a welding bar having a hot surface lined with a fabric of a non-adhesive material against the sheet, such that the imprinted side of the sheet being on the inside of the bag.

16. The process of claim 15 comprising imprinting said stripe substantially rectilinearly and longitudinally on the imprinted side of the sheet.

17. The process of claim 16 comprising imprinting on said first flexible sheet three of said stripes.

18. The process of claim 16 comprising imprinting with the fabric made of polytetrafluoroethylene.

19. The process of claim 16 comprising imprinting with the fabric having 5 to 20 meshes/cm.

20. The process of claim 19 comprising imprinting with the fabric having 12 meshes/cm.

21. The process of claim 16 comprising imprinting the wall with at least one rough stripe which wall is a multi-layer sheet in which the most internal layer is polyethylene.

22. A process of manufacturing a tube of a synthetic material for vacuum preservation of foodstuffs, comprising the steps of:
mutually joining two walls made of flexible sheets of a synthetic material along opposite lateral welding lines;
imprinting on one side of a first of the flexible sheets forming the walls with at least one rough stripe made by pressing a welding bar having a hot surface lined with a fabric of a non- adhesive material against the sheet, such that the imprinted side of the sheet being on the inside of the tube.
